(19) United States
(12) Patent Application Publication
(10) Pub. No.: US 2025/0100402 A1
(43) Pub. Date: Mar. 27, 2025

(54) CHARGING PORT ASSEMBLY FOR ELECTRIFIED VEHICLE

(71) Applicant: Ford Global Technologies, LLC, Dearborn, MI (US)

(72) Inventors: Stuart C. Salter, White Lake, MI (US); Michael Kevin Martin, Livonia`, MI (US); Katherine Rouen, Livonia, MI (US); John Paul Modzel, Farmington Hills, MI (US); Justin Poiner, Wixom, MI (US); Dawn Piechocki, Gross Pointe Park, MI (US)

(21) Appl. No.: 18/373,565

(22) Filed: Sep. 27, 2023

(51) Int. Cl. B60L 53/16; B60L 1/02; B60L 53/10; B62D 25/24

(52) U.S. Cl. CPC B60L 53/16; B60L 1/02; B60L 53/11; B62D 25/24; B60L 2240/36

(57) ABSTRACT

A charging port assembly may include a charging port configured to couple to a plug to charge the electrified vehicle. A charging port assembly may include a first flap moveable between a closed position and at least one open position by movement about an axis adjacent a top of the charging port. A charging port assembly may include a second flap moveable between a closed position and at least one open position by movement about the axis.

### TECHNICAL FIELD

This disclosure relates to a charging port assembly for an electrified vehicle and a corresponding method.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery is a relatively high-voltage battery that selectively powers the electric machines and other electrical loads of the electrified vehicle. The traction battery of a plug-in electrified vehicle may be charged at public or private electrified vehicle charging stations, for example. Plug-in electrified vehicles include a charging port configured to couple to a plug of the electrified vehicle charging station. When the plug is coupled to the charging port, the electrified vehicle charging station may charge the traction battery.

### SUMMARY

In some aspects, the techniques described herein relate to a charging port assembly for an electrified vehicle, including: a charging port configured to couple to a plug to charge the electrified vehicle; a first flap moveable between a closed position and at least one open position by movement about an axis adjacent a top of the charging port; and a second flap moveable between a closed position and at least one open position by movement about the axis.

In some aspects, the techniques described herein relate to a charging port assembly, wherein: the first flap is configured to cover a first portion of the charging port when in the closed position, and the second flap is configured to cover a second portion of the charging port when in the closed position.

In some aspects, the techniques described herein relate to a charging port assembly, wherein: the first flap is moveable to the at least one open position independent of the second flap such that, when the first flap is in the at least one open position and the second flap is in the closed position, the first portion of the charging port is exposed and the second flap covers the second portion of the charging port.

In some aspects, the techniques described herein relate to a charging port assembly, wherein the second flap includes a cutout and the first flap includes a solid body configured to cover the cutout when the first and second flaps are in the respective closed positions.

In some aspects, the techniques described herein relate to a charging port assembly, wherein: when both the first and second flaps are in the respective closed positions, movement of the second flap to the at least one open position results in corresponding movement of the first flap such that both the first and second portions of the charging port are exposed.

In some aspects, the techniques described herein relate to a charging port assembly, wherein the first portion of the charging port is configured to couple to a first type of standard charging plug, and the combined first and second portions of the charging port are configured to couple to a second type of standard charging plug different than the first type of standard charging plug.

In some aspects, the techniques described herein relate to a charging port assembly, wherein the first type of standard charging plug is an SAE J1772 plug, and the second type of standard charging plug is a Combined Charging System plug.

In some aspects, the techniques described herein relate to a charging port assembly, wherein the second portion of the charging port includes pins configured to permit DC fast-charging.

In some aspects, the techniques described herein relate to a charging port assembly, wherein: both the first flap and the second flap are moveable to a first open position and a second open position, when in the first open position, the first and second flaps have rotated about the axis by a first angle, and when in the second open position, the first and second flaps have rotated about the by a second angle greater than the first angle.

In some aspects, the techniques described herein relate to a charging port assembly, wherein the first angle is about 90° and the second angle is about 135°.

In some aspects, the techniques described herein relate to a charging port assembly, wherein: the first and second flaps are each coupled to respective arm, each respective arm extends from the axis to a respective one of the first and second flaps, each respective arm includes a first notch corresponding to the first open position and a second notch corresponding to the second open position, a rod is biased toward the first and second notches, and when the first and second flaps are in the first or second open positions, the rod is configured to enter a corresponding notch to hold the first and second flaps in the corresponding first or second open positions.

In some aspects, the techniques described herein relate to a charging port assembly, wherein: each respective arm includes a third notch corresponding to a closed position, and when the first and second flaps are in the closed open position, the rod is configured to enter the third notch to hold the first and second flaps in the closed position.

In some aspects, the techniques described herein relate to a charging port assembly, wherein the arms include an arcuate section.

In some aspects, the techniques described herein relate to a charging port assembly, wherein the first and second notches are on an upper surface of the arm, and the rod is arranged adjacent the upper surface.

In some aspects, the techniques described herein relate to a charging port assembly, further including: a controller; and a current source, wherein the controller is configured to selectively direct current to a heater to heat the charging port, and wherein the controller is configured to selectively direct current to the heater based on a first heater control technique or a second heater control technique.

In some aspects, the techniques described herein relate to a charging port assembly, wherein the first heater control technique includes continuous activation of the heater, and wherein the second heater control technique includes activating the heater based on an expected return time of a user to the electrified vehicle.

In some aspects, the techniques described herein relate to a method, including: moving a first flap of a charging port assembly between a closed position and at least one open position by movement about an axis adjacent a top of a charging port; and moving a second flap of the charging port assembly between a closed position and at least one open position by movement about the axis.

In some aspects, the techniques described herein relate to a method, wherein: when the first flap is in the at least one open position and the second flap is in the closed position, a first portion of the charging port is exposed, and when both the first and second flaps are in respective at least one open positions, the first portion of the charging port and a second portion of the charging port are exposed.

In some aspects, the techniques described herein relate to a method, further including: coupling a first type of standard charging plug to the first portion of the charging port when the first flap is in the at least one open position and the second flap is in the closed position, and coupling a second type of standard charging plug to the first and second portions of the charging port when both the first and second flaps are in respective at least one open positions, wherein the second type of standard charging plug is different than the first type of standard charging plug.

In some aspects, the techniques described herein relate to a method, further including: heating the charging port either continuously or based on an expected return time of a user.

### BRIEF DESCRIPTION OF THE DRAWINGS

FIG. 1 schematically illustrates various components, including a powertrain, of an electrified vehicle relative to a DC fast charger.

FIG. 2 schematically illustrates various components, including the powertrain, of the electrified vehicle relative to an AC charger.

FIG. 3 illustrates a charging port assembly of the present disclosure with first and second flaps in a first open position.

FIG. 4 illustrates the charging port assembly with first and second flaps in a closed position.

FIG. 5 illustrates the charging port assembly with the first flap in a first open position, and the second flap in a closed position.

FIG. 6 illustrates the charging port assembly with the first and second flaps in a second open position.

FIG. 7 is a side view of the charging port assembly with first and second flaps in the first open position.

FIG. 8 is a side view of the charging port assembly with first and second flaps in the second open position.

FIG. 9 schematically illustrates a heater of the charging port assembly.

### DETAILED DESCRIPTION

This disclosure relates to a charging port assembly for an electrified vehicle and a corresponding method. This disclosure provides convenient access to one or more portions of a charging port by selective movement of one of two flaps. When in an open position, the flaps cover the charging port from above and prevent the ingress of falling rain or snow relative to the charging port. The charging port may also be heated according a particular heater control technique to prevent buildup of rain, snow, or ice relative to the charging port. These and other benefits will be appreciated from the following written description.

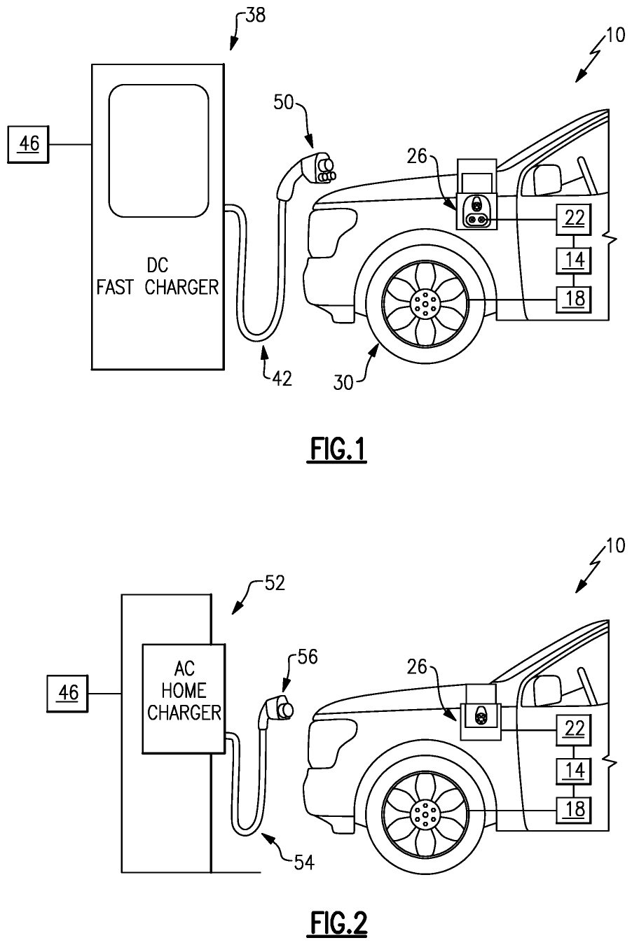

Referring to the drawings, FIG. 1 illustrates an example electrified vehicle 10. The electrified vehicle 10 includes a battery 14 (e.g., a battery pack), an electric machine 18, a controller 22, a charging port 26, and wheels 30. The electric machine 18 is configured to receive electric power from the battery 14, and to convert that electric power to torque to drive the wheels 30. The battery 14 is a relatively high voltage traction battery in one example.

In FIG. 1, an example set of electric vehicle supply equipment (EVSE) 38 is shown. The EVSE 38 includes a cord set 42 in this example. For purposes of this disclosure, the term EVSE includes any device separate from the electrified vehicle 10 that can be used to charge the battery 14.

To charge the battery 14, the cord set 42 electrically couples the battery 14 to a power source outside the vehicle 10, such as a grid power source (“grid”) 46. The cord set 42 includes a plug 50, which includes a handle, to connect the cord set 42 to the charging port 26.

In FIG. 1, the plug 50 exhibits a standard configuration corresponding to DC fast charging. In this regard, the EVSE 38 may be referred to as a DC fast charger, or a DC fast charging station. The EVSE 38 may be provided at a public charging station. The plug 50 is a Combined Charging System plug in one example. In the example, the plug 50 includes pins corresponding to a standard J1772 plug plus an additional two pins configured to facilitate DC fast charging.

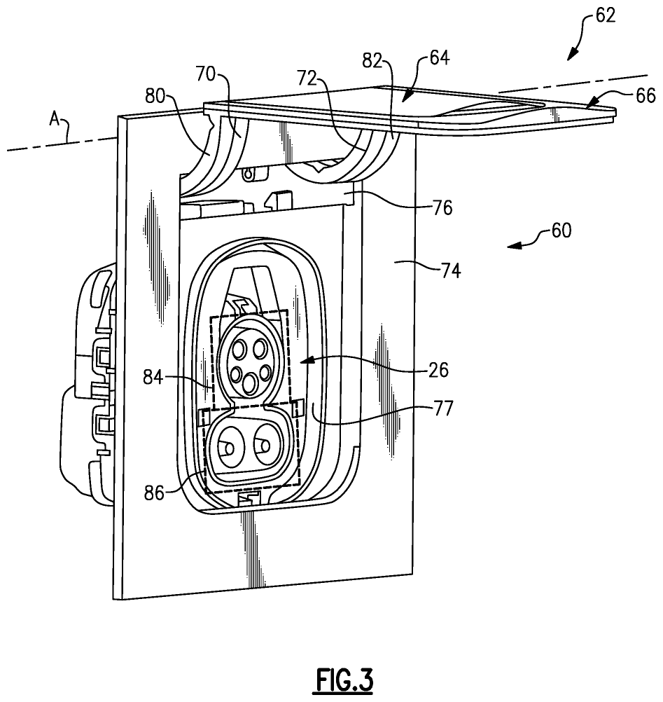

The charging port 26 is also configured to couple to a plug exhibiting another type of standard configuration, as shown in FIG. 2. In FIG. 2, another EVSE 52 includes a cord set 54 configured to electrically couple the battery 14 to a power source outside the vehicle 10, such as the grid 46. The cord set 54 includes a plug 56. In FIG. 2, the plug 56 exhibits a standard configuration corresponding to AC charging. In this regard, the EVSE 52 may be referred to as an AC charger. The EVSE 52 may be provided at a home of a user, and may be referred to as an AC home charger. The plug 56 includes pins corresponding to a standard J1772 plug, and lacks pins that facilitate DC fast charging, in this example. Additional detail of a charging port 26 will be provided below.

It should be understood that the controller 22 could be part of an overall vehicle control module, such as a vehicle system controller (VSC) or body control module (BCM). Alternatively, the controller 22 may be a stand-alone controller separate from the VSC and the BCM. Further, the controller 22 may be programmed with executable instructions for interfacing with and operating the various components of the electrified vehicle 10. The controller 22 additionally includes a processing unit and non-transitory memory for executing the various control strategies and modes of the electrified vehicle 10.

The electrified vehicle 10 is an all-electric vehicle in this example, such as a battery electric vehicle (BEV). In other examples, the electrified vehicle 10 is a plug-in hybrid electric vehicle (PHEV), which selectively drives wheels using torque provided by an internal combustion engine instead of, or in addition to, the electric machine 18. This disclosure is not limited to the electrified vehicle 10 of FIG. 1 and the teachings of this disclosure could apply to, among other things, any electrified vehicle that includes a charging port. Further, while a pickup truck is shown in FIG. 1, this disclosure extends to other types of vehicles such as sedans, vans, sport utility vehicles (SUVs), sports cars, etc.

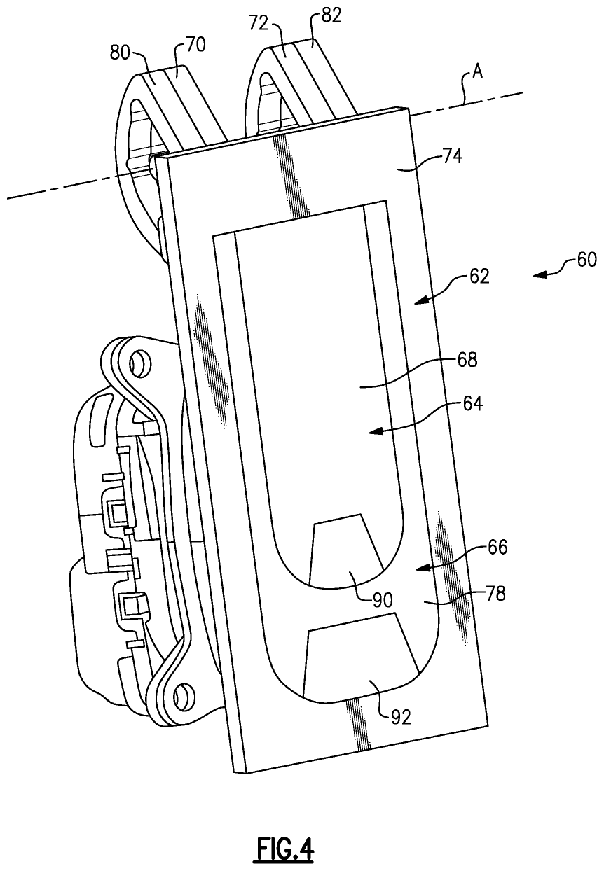

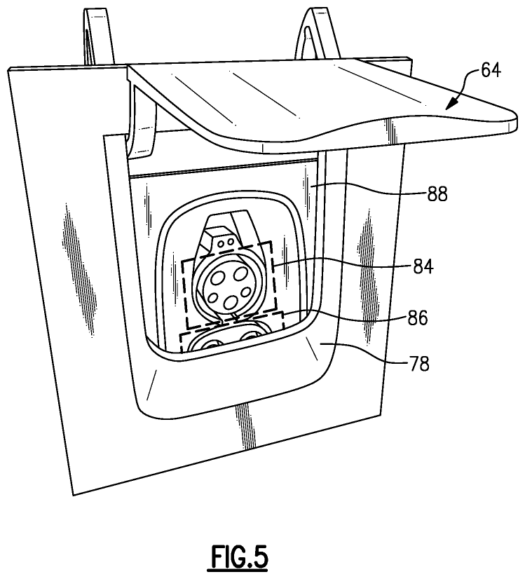

FIGS. 3 and 4 illustrate a charging port assembly 60. The charging port assembly 60 includes the charging port 26 and a cover assembly 62 configured to selectively cover and expose the charging port 26. The cover assembly 62 includes a first flap 64 and a second flap 66.

The first flap 64 includes a solid body panel 68, which is connected to first and second arms 70, 72, which are pivotably mounted to a housing 74 about an axis A. The axis A may be substantially parallel to a ground surface adjacent the electrified vehicle 10, and the axis A may be substantially perpendicular to the direction of the force of gravity.

The housing 74 may be a body panel of the vehicle 10 or a structure separate from, but attached to, a body panel of the vehicle 10. The axis A is adjacent a top of the charging port 26. In this example, the axis A is vertically spaced-apart above the charging port 26. As shown in FIG. 3, the arms 70, 72 project through a slot 76 in the housing 74. The slot 76 is vertically above a recess 77 in the housing 74 which receives the charging port 26. The first flap 64 is moveable between a closed position (FIG. 4) and at least one open position, one of which is shown in FIG. 3, by movement about axis A.

The second flap 66 includes a body panel 78, which is connected to first and second arms 80, 82, which are pivotably mounted to the housing 74 about the axis A. The body panel 78 exhibits a greater height and width than the body panel 68. The second flap 66 is moveable between a closed position (FIG. 4) and at least one open position, one of which is shown in FIG. 3, by movement about axis A. Arms 70, 72, 80, 82 include both a straight section and an arcuate section in this example. Optionally, a rotational damper may be applied to the arms 70, 72, 80, 82.

The charging port 26 in this example includes a first portion 84 and a second portion 86. The first portion 84 is configured to couple to a first type of standard charging plug, and the combined first and second portions 84, 86 are configured to couple to a second type of standard charging plug different than the first type of standard charging plug. In an example, the first portion 84 includes a plurality of pins configured to facilitate coupling to a plug for AC charging, and the second portion 86 includes pins configured to facilitate coupling to a plug for DC fast charging. In a further example, the first type of standard charging plug is an SAE J1772 plug, such as plug 56 in FIG. 2, and the second type of standard charging plug is a Combined Charging System (CCS) plug, such as plug 50 in FIG. 1.

The first flap 64 is configured to cover the first portion 84 of the charging port when in the closed position, and the second flap 66 is configured to cover the second portion 86 when in the closed position. Further, in this disclosure, it is possible to expose only the first portion 84 of the charging port 26 by moving the first flap 64 relative to the second flap 66 and while the second flap 66 remains stationary.

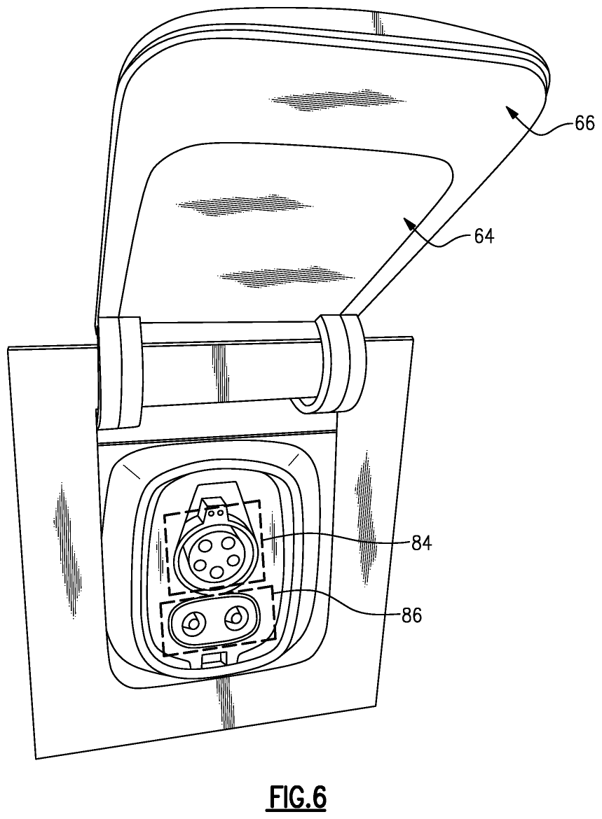

The first flap 64 is moveable to an open position independent of the second flap 66 such that, when the first flap 64 is in the open position and the second flap 66 is in the closed position, the first portion 84 is exposed and the second flap 66 covers the second portion 86, as shown in FIG. 5. In FIG. 5, the charging port 26 is configured to couple to a plug like plug 56.

In this disclosure, the reference to the flaps 64, 66 covering one of the portions 84, 86 includes at least partially or fully covering the respective portion 84, 86 such that a plug cannot couple to that portion. Likewise, reference to the flaps 64, 66 exposing one of the portions 84, 86 refers to the flaps 64, 66 being in a position where a plug can couple to that portion.

As shown in FIG. 5, the body panel 78 includes a cutout 88 such that the body panel 78 is substantially U-shaped in this example, such that rotation of the first flap 64 to an open position exposes the first portion 84. The body panel 78 may include a groove or recess about the edge of the cutout 88 configured to at least partially receive the body panel 68. In this regard, the first flap 64 may be nestable within the second flap 66 when both the first and second flaps 64, 66 are in the closed positions. The body panel 68 is sized and shaped to fully cover the cutout 88 and to at least partially overlap body panel 78 adjacent the sides and bottom of body panel 68. Further, the first and second flaps 64, 66 may each include raised lips 90, 92 (FIG. 4) adjacent a bottom edge thereof to facilitate a user grasping a corresponding one of the first and second flaps 64, 66.

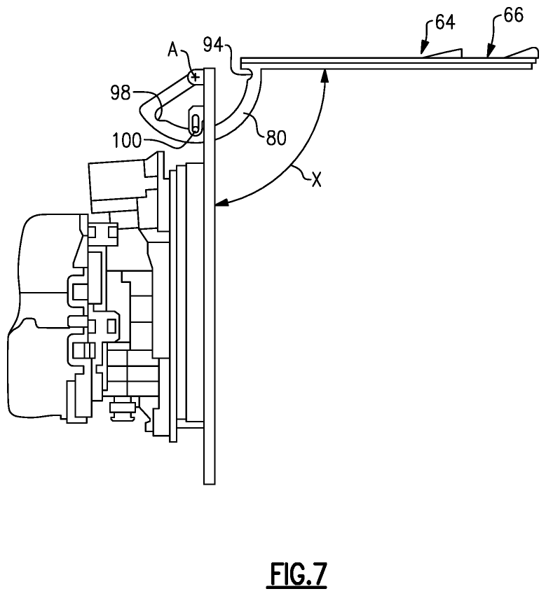

When both the first and second flaps 64, 66 are in the respective closed positions, movement of the second flap 66 an open position results in corresponding movement of the first flap 64 to an open position, such that both the first and second portions 84, 86 are exposed, as shown in FIG. 6. In this regard, because the first flap 64 partially overlaps the second flap 66, and the second flap 66 is arranged generally closer to the charging port 26 than the first flap 64, movement of the second flap 66 away from the closed position will also result in movement of the first flap 64 away from the closed position. In the configuration of FIG. 6, the charging port 26 is configured to couple to a plug like the plug 50. Movement of the second flap 66 to the open position provides one with access to the first and second portions 84, 86 of the charging port 26 with a single movement.

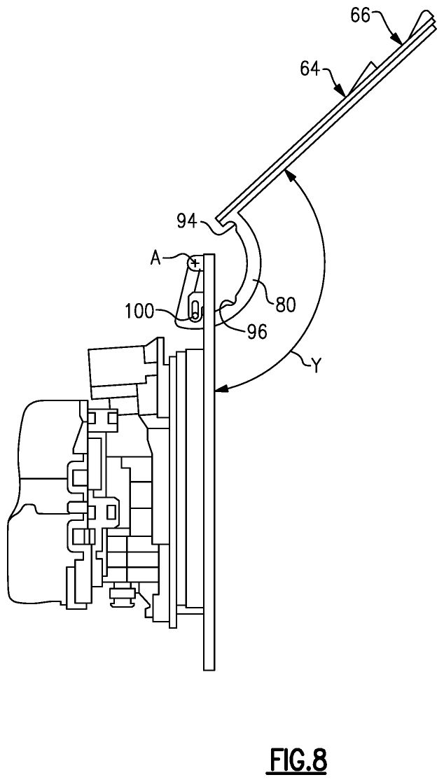

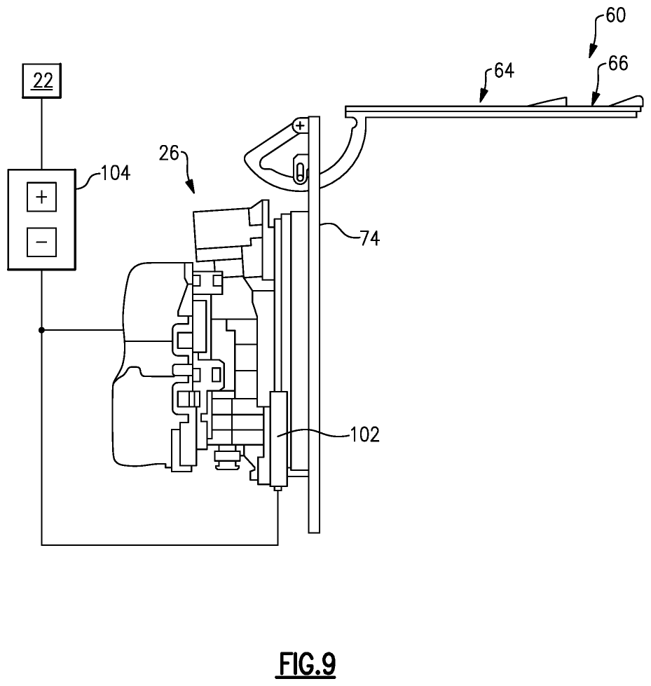

In one aspect of this disclosure, both the first flap 64 and the second flap 66 are moveable to a first open position and a second open position. FIG. 7 illustrates the first and second flaps 64, 66 in the first open position. In the first open position, the first and second flaps 64, 66 have rotated about the axis A in generally an upward and outward direction by a first angle X. FIG. 8 illustrates the first and second flaps 64, 66 in the second open position, the first and second flaps 64, 66 have rotated about the axis A generally in the upward and outward directions by a second angle Y, which is greater than the first angle X. In an embodiment, the first angle is about 90° and the second angle is about 135°. When the first or second flaps 64, 66 are in an open position, the first and second flaps 64, 66 prevent falling snow or rain, for example, from coming into contact with the charging port 26.

In another aspect of this disclosure, the charging port assembly 60 is configured to hold the first and second flaps 64, 66 in the closed position, the first open position, and the second open position. With respect to FIGS. 7 and 8, which shows the arm 80, an upper surface of the arm 80 includes three notches spaced-apart from one another. A first notch 94 corresponds to the closed position, a second notch 96 corresponds to the first open position, and a third notch 98 corresponds to a second open position. While only the arm 80 is shown, the arms 70, 72, and 82 of the first and second flaps 64, 66 may be configured similarly.

The charging port assembly 60 further includes a rod 100 biased toward the top surface of the arm 80 and configured to enter into the notches 94 96 98 when a corresponding one of the notches 94, 96, 98 is aligned with the rod 100. The engagement between the rod 100 and a corresponding one of the notches 94, 96, 98 provides a force holding the flap 66, in this example, in a corresponding closed, first open, or second open position. The force may be sufficient to hold the flap 66, in this example, in a particular position, and may resist the weight of the flaps 64, 66 to return to the closed position, for example. The force may also resist the weight of the flaps 64, 66 plus some accumulated snow or ice. The force applied by the rod 100, however, may be overcome by a user applying a force to a corresponding one of the flaps 64, 66.

Another aspect of this disclosure relates to actively heating the charging port 26. In this aspect, the charging port assembly 60 includes a heater. The heater may include a heater element 102, such as a heater wire, and/or the heater may be provided by a material, or a coating, of the charging port 26 itself. As shown in FIG. 9, the charging port assembly 60 may include a heater element 102 incorporated into the charging port 26 or provided adjacent the charging port 26, such as by being incorporated into housing 74. The heater element 102 is electrically coupled to a current source 104, which is electrically coupled to the controller 22. The current source 104 is responsive to instructions from the controller 22 to selectively activate the heater element 102. An example control scheme will be discussed below.

The heater element 102, in one example, includes at least one resistive heater wire. In a further example, the heater element 102 includes a plurality of resistive heater wires. The resistive heater wire(s) may be made of an electrically conductive material that also creates enough resistance to generate heat, such as nichrome (NiCr).

The current source 104 could be a high voltage battery, a low voltage battery, or an external power source. When commanded by the controller 22, the current source 104 passes current through the heater element 102, which causes the heater element 102 to generate heat. The heat generated by the heater element 102 is used to prevent the accumulation of ice or snow adjacent the charging port 26, or to melt the same if already present.

The heater element 102 is at least partially insert-molded with the charging port 26. Insert-molding is the process of molding or forming a part around another part. The heater element 102 could be insert-molded into housing 74 in another example.

In one example, in order to better-conduct the heat generated by the heater element 102, the charging port 26 is made of a thermally conductive polymer material. Alternatively, the charging port 26 can include, or be coated with, a thermally conductive material which is configured to generate heat when current from the current source 104 flows relative to that material.

The thermally conductive polymer has a thermal conductivity of greater than about 10 watts per meter-Kelvin (W/m-K). In a particular example, the thermally conductive polymer has a thermal conductivity of about 14 W/m-K. These values are in stark contrast to the thermal conductivity of ordinary polymer materials, which are typically around 0.5 W/m-K or less. One known thermally conductive polymer is CoolPoly®, made commercially available by Celanese Corporation.

A method of heating the charging port 26 will now be described. The method will be performed by the controller 22 and other components of the electrified vehicle 10, such as those discussed above relative to FIGS. 1-9. Further, while one example method is described, it should be understood that a user-override is contemplated in this disclosure. That is, the user may intervene and manually turn the heater element on or off, as desired, thereby overriding the method. In one example, control of the heater element is accomplished via one or more buttons in the infotainment system of the electrified vehicle 10.

In a particular aspect of this disclosure, the controller 22 is configured to selectively direct current to the heater, which again may either be the heater element 102 or the charging port 26 itself, based on environmental conditions and a user input of a preference for a first heater control technique or a second heater control technique. The first heater control technique includes continuous activation of the heater, and the second heater control technique includes activating the heater based on an expected return time of a user to the electrified vehicle.

In an example method, the controller 22 uses information from one or more sensors to determine that ice and/or snow may accumulate on the charging port 26. The information may include information from a rain sensor and information from a temperature sensor associated with the electrified vehicle 10. If the controller 22 determines that ice and/or snow may accumulate on the charging port 26, then the controller 22 issues commands the heater of the charging port 26 according to one of two heater control techniques. In a first example, the controller 22 issues commands associated with the first or second heater control technique based on a preference input by a user. In a second example, the controller 22 issues commands the first or second heater control technique based on a confidence level associated with an estimated return time of the user to the electrified vehicle 10.

The controller 22 may estimate the return time of the user to the electrified vehicle 10 based on usage data of the electrified vehicle 10 over time, location data (i.e., GPS data), day of the week, time of day, etc. For instance, if the user has parked the electrified vehicle 10 near their place of work, and the user is nearing completion of their workday, the controller 22 may indicate a high level of confidence that the user is soon to return to the electrified vehicle 10. On the other hand, if the user has parked the electrified vehicle 10 in a new location, the electrified vehicle 10 may indicate a low level of confidence associated with an expected return time of the user to the electrified vehicle 10.

In one example, the first heater control technique heats the charging port 26 continuously and at a level based on one or more environmental factors. In an example, the first heater control technique includes the controller 22 issuing a command to the heater to heat the charging port at a particular level based on a snowfall rate and/or an environmental temperature.

In an example, the second heater control technique heats the charging port 26 when the user is expected to return to the electrified vehicle 10. In a specific example, the second heater control technique includes the controller 22 issuing a command to the heater to heat the charging port beginning at a preset time, such as 10 minutes, before the user is expected to return to the electrified vehicle 10. For example, if the user is parked adjacent their workplace, on a workday, and the user usually returns to the electrified vehicle at 5 PM, then the controller 22 will command the heater to begin heating the charging port 26 at 4:50 PM. The particular level of heating applied is based on a snowfall rate and/or an environmental temperature, in the example.

It should be understood that terms such as “about” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A charging port assembly for an electrified vehicle, comprising:
a charging port configured to couple to a plug to charge the electrified vehicle;
a first flap moveable between a closed position and at least one open position by movement about an axis adjacent a top of the charging port; and
a second flap moveable between a closed position and at least one open position by movement about the axis.

2. The charging port assembly as recited in claim 1, wherein:
the first flap is configured to cover a first portion of the charging port when in the closed position, and
the second flap is configured to cover a second portion of the charging port when in the closed position.

3. The charging port assembly as recited in claim 2, wherein:
the first flap is moveable to the at least one open position independent of the second flap such that, when the first flap is in the at least one open position and the second flap is in the closed position, the first portion of the charging port is exposed and the second flap covers the second portion of the charging port.

4. The charging port assembly as recited in claim 3, wherein the second flap includes a cutout and the first flap includes a solid body configured to cover the cutout when the first and second flaps are in the respective closed positions.

5. The charging port assembly as recited in claim 2, wherein:
when both the first and second flaps are in the respective closed positions, movement of the second flap to the at least one open position results in corresponding movement of the first flap such that both the first and second portions of the charging port are exposed.

6. The charging port assembly as recited in claim 2, wherein the first portion of the charging port is configured to couple to a first type of standard charging plug, and the combined first and second portions of the charging port are configured to couple to a second type of standard charging plug different than the first type of standard charging plug.

7. The charging port assembly as recited in claim 6, wherein the first type of standard charging plug is an SAE J1772 plug, and the second type of standard charging plug is a Combined Charging System plug.

8. The charging port assembly as recited in claim 2, wherein the second portion of the charging port includes pins configured to permit DC fast-charging.

9. The charging port assembly as recited in claim 1, wherein:
both the first flap and the second flap are moveable to a first open position and a second open position,
when in the first open position, the first and second flaps have rotated about the axis by a first angle, and
when in the second open position, the first and second flaps have rotated about the by a second angle greater than the first angle.

10. The charging port assembly as recited in claim 9, wherein the first angle is about 90° and the second angle is about 135°.

11. The charging port assembly as recited in claim 9, wherein:
the first and second flaps are each coupled to respective arm,
each respective arm extends from the axis to a respective one of the first and second flaps,
each respective arm includes a first notch corresponding to the first open position and a second notch corresponding to the second open position,
a rod is biased toward the first and second notches, and
when the first and second flaps are in the first or second open positions, the rod is configured to enter a corresponding notch to hold the first and second flaps in the corresponding first or second open positions.

12. The charging port assembly as recited in claim 11, wherein:
each respective arm includes a third notch corresponding to a closed position, and
when the first and second flaps are in the closed open position, the rod is configured to enter the third notch to hold the first and second flaps in the closed position.

13. The charging port assembly as recited in claim 11, wherein the arms include an arcuate section.

14. The charging port assembly as recited in claim 11, wherein the first and second notches are on an upper surface of the arm, and the rod is arranged adjacent the upper surface.

15. The charging port assembly as recited in claim 1, further comprising:
a controller; and
a current source, wherein the controller is configured to selectively direct current to a heater to heat the charging port, and wherein the controller is configured to selectively direct current to the heater based on a first heater control technique or a second heater control technique.

16. The charging port assembly as recited in claim 15, wherein the first heater control technique includes continuous activation of the heater, and wherein the second heater control technique includes activating the heater based on an expected return time of a user to the electrified vehicle.

17. A method, comprising:
moving a first flap of a charging port assembly between a closed position and at least one open position by movement about an axis adjacent a top of a charging port; and
moving a second flap of the charging port assembly between a closed position and at least one open position by movement about the axis.

18. The method as recited in claim 17, wherein:
when the first flap is in the at least one open position and the second flap is in the closed position, a first portion of the charging port is exposed, and
when both the first and second flaps are in respective at least one open positions, the first portion of the charging port and a second portion of the charging port are exposed.

19. The method as recited in claim 18, further comprising:
coupling a first type of standard charging plug to the first portion of the charging port when the first flap is in the at least one open position and the second flap is in the closed position, and
coupling a second type of standard charging plug to the first and second portions of the charging port when both the first and second flaps are in respective at least one open positions, wherein the second type of standard charging plug is different than the first type of standard charging plug.

20. The method as recited in claim 17, further comprising:
heating the charging port either continuously or based on an expected return time of a user.
